(19) United States
(12) Patent Application Publication
(10) Pub. No.: US 2015/0093578 A1
(43) Pub. Date: Apr. 2, 2015

(54) METHOD OF MANUFACTURING ALANE INCLUDING DESOLVATION OF AN ALANE -ETHERATE COMPLEX

(71) Applicant: Intelligent Energy Inc., San Jose, CA (US)

(72) Inventor: Allison Fisher, Valley City, OH (US)

(73) Assignee: Intelligent Energy Inc.

(21) Appl. No.: 14/558,155

(22) Filed: Dec. 2, 2014

Related U.S. Application Data
(63) Continuation of application No. PCT/US2013/043981, filed on Jun. 10, 2013.
(60) Provisional application No. 61/655,509, filed on Jun. 5, 2012.
(60) Provisional application No. 61/732,962, filed on Dec. 4, 2012.
(60) Provisional application No. 61/655,511, filed on Jun. 5, 2012.

(51) Int. Cl. B01J 2/06; D01D 5/00; C01B 6/06

(52) U.S. Cl. CPC B01J 2/06; C01B 6/06; D01D 5/0007
USPC 428/402; 423/645; 264/10

(57) ABSTRACT

The invention relates to methods of preparing α-alane by desolvating an alane-etherate complex. The methods include electrospraying or electrospinning the alane-etherate complex in order to remove solvent. Solid alane is obtained and can be in either fine particulate form or fiber form. The alane can be encapsulated with a stabilizing agent.

### TECHNICAL FIELD

This invention relates to a method for desolvating an alane-etherate complex to create alane.

### BACKGROUND

A key limiting factor in the widespread adoption of proton exchange membrane fuel cell (PEMFC) based power systems is hydrogen fuel storage. The development of a viable hydrogen storage solution will have a profound impact on how consumers will power portable devices, since batteries simply cannot match demands for runtime, energy density and reliability.

Because hydrogen has poor energy content per volume (0.01 kJ/L at STP and 8.4 MJ/L for liquid hydrogen vs. 32 MJ/L for petroleum), physical transport and storage as a gas or liquid is impractical. Additionally, the compression process to achieve the pressures necessary to reach a high density is energy-intensive and doesn't solve the hazard issue. Also, the densities of compressed H₂ or liquefied H₂ are still below those required to reach practical fuel storage goals.

Physical means to store hydrogen include sorbents such as carbon nanotubes and foams, zeolites, metal-organic frameworks; and intermetallics such as titanium-manganese alloy 5800, complex hydrides such as metal alanates, amides, and borohydrides, and chemical hydrides such as sodium borohydride/water and ammonia borane (AB). Despite intensive and elegant work on sorbents and complex hydrides, practical systems that can store and release ≧6wt % hydrogen at moderate temperatures are still far from realization.

Alane is an attractive candidate for solid hydrogen storage and release because it has a density of 1.48 g/cm³ and releases up to 10 weight percent hydrogen and aluminum in a single step upon heating to ≦200° C. Alane can be formed from the desolvation of labile alane-ligand complexes such as alane-etherate. Alane's formula is sometimes represented with the formula (AlH₃)ₙ because it is a polymeric network solid. Alane is formed as numerous polymorphs: the alpha (α), alpha prime (α′), beta (β), delta (δ), epsilon (ε), zeta (ζ), or gamma (γ) polymorphs. Each of the polymorphs has different physical properties and varying stability. The most thermally stable polymorph is α-alane, featuring aluminum atoms surrounded by six hydrogen atoms that bridge to six other aluminum atoms. The Al-H distances are all equivalent and the Al-H-Al angle is approximately 141°. While α-alane's crystals have a cubic or hexagonal morphology, α′-alane forms needlelike crystals and γ-alane forms a bundle of fused needles. Typically, the lightweight, unstable γ-alane is produced first, converting under certain conditions to the more stable rhombohedral β-alane polymorph first, then to α-alane. When trace amounts of water are present during crystallization the δ-alane and ε-alane can be formed. The ζ-alane polymorph is prepared by crystallization from di-n-propyl ether. The α′, δ, ε, and ζ polymorphs do not convert to α-alane upon heating and are less thermally stable than α-alane.

Crystalline alane has many uses including: hydrogen storage, inorganic and organic synthesis, as an ingredient in propellants and pyrotechnics, as a polymerization catalyst, and as a precursor to aluminum films and coatings. Consequently there has been considerable research carried out on the preparation of alane, since the first report of its preparation in 1942 (Stecher and Wiberg, Ber. 1942, 75, 2003). Finholt, Bond, and Schlesinger reported an improved method of synthesis of alane-diethyl etherate in 1947 which has formed the foundation for most of the reported methods for the synthesis of non-solvated crystalline alane (J. Am. Chem. Soc., 1947, 69, 1199). The reaction is shown below, and the amount of ether complexed to the alane product depended on the length and temperature of the drying step of the reaction.

3LiAlH₄+AlCl₃→4AlH₃+3LiCl.

Reports describing the preparation and stabilization of non-solvated crystalline alane began to appear in the patent literature in 1974 (Scruggs, U.S. Pat. No. 3,801,657, Roberts et al. U.S. Pat. No. 3,803,082, King, U.S. Pat. No. 3,810,974, Matzek et al. U.S. Pat. No. 3,819,819, Daniels et al. US3819335, Roberts, U.S. Pat. No. 3,821,044, Brower et al. U.S. Pat. No. 3,823,226, Schmidt et al. U.S. Pat. No. 3,840,654, and Self et al. U.S. Pat. No. 3,844,854). Removal of the residual diethyl ether was effected by using higher than stoichiometric ratios of complex aluminum hydride to aluminum chloride, as well as inclusion of lithium borohydride as a “seeding” or “crystallization” agent. Several patents describe the use of sodium aluminum hydride instead of lithium aluminum hydride (Ashby et al. U.S. Pat. No. 3,829,390, and Kraus et al. U.S. Pat. No. 3,857,930). As disclosed in these patents and Brower et al. (“Brower”), “Preparation and Properties of Aluminum Hydride,” J. Am. Chem. Soc., 1976, 98, 2450, alane is usually synthesized by reacting aluminum trichloride (AlCl₃) and metal aluminum hydride (MAlH₄) in diethyl ether or diethyl ether-hydrocarbon solvent mixtures. The aluminum trichloride was dissolved in diethyl ether at −10° C. A minimum of three mole equivalents of MAlH₄ was added to the aluminum trichloride solution to produce a solvated alane-ether complex and a precipitate of metal chloride (MCl, e.g. LiCl or NaCl). In order to desolvate the alane-ether complex, 0.5 to 4.0 mole equivalents of a borohydride salt, such as lithium borohydride or sodium borohydride, was mixed with the solution including the alane-ether complex. The mixture was filtered and the filtrate was diluted with toluene or benzene to provide an ether to toluene or benzene ratio of 15:85. The mixture was heated to 85° C. to 95° C. to desolvate the alane-ether complex and the diethyl ether was subsequently removed by distillation. The precipitated alane was recovered by aqueous acid quenching, filtration, and washing. Brower also discloses that the reaction is conducted in the absence of water, oxygen, and other reactive species because if water is present, the δ and ε polymorphs are undesirably formed.

The methods reported for stabilization of the reactive alane product during this time included in situ or subsequent treatment of alane with an alkyl or aryl silicol, coating the alane surface with an organic compound containing at least one phenyl group or a condensed ring structure, and washing the alane product (often with some amount of magnesium included in the preparation step) with an aqueous solution buffered at from about pH 6 to 8.

However, the large volumes of solvent required as well as the excess aluminohydride and borohydride salts used to desolvate the alane-ether complex make these syntheses of α-alane expensive. The borohydride salts also generate byproducts that require disposal. Furthermore, the alane produced by the method of Brower is typically contaminated with undesirable polymorphs and is prone to decomposition during desolvation.

Alternatively, as described in French Patent No. FR2245569 (1975), to desolvate and crystallize the α-polymorph, the diethyl ether may be removed from the crystallization solution, such as by distilling the diethyl ether. The distillation can be carried out between 50° and 85° C. At the bottom of this range, between 50° and 65° C., etherate intermediate is formed and is converted into α-alane. However, at the top of this range, between 65° and 85° C., etherate aluminum hydride does not appear and stable α-alane precipitates are formed almost immediately. By keeping the mixture in 8% to 10% of ether after the initial distillation, a final α-alane product may be obtained with superior features. Retention of the ether allows the rearrangement of alane during the conversion to the a form of alane as thermal decomposition of the crystal is reduced and the final product is crystalline.

As yet another alternative, the solvent may be removed from alane by vacuum drying at temperatures between 30° C. and 90° C. This process may be enhanced when a desolvating species is present such as a complex metal hydride (LiAl₄, LiBH₄) or a metal halide (e.g., LiCl). See, e.g., A. N. Tskhai et al. Rus. J. Inorg. Chem. 37:877 (1992), and U.S. Pat. No. 3,801,657 to Scruggs. The desolvating species can be removed with a solvent that preferentially dissolves the desolvating species over the metal hydride. The desolvating species can also be removed with a solvent that preferentially dissolves the metal hydride over the desolvating species (as disclosed in U.S. Pat. No. 3,453,089 to Guidice). After removal the desolvating species can be recovered for further use.

Yet another alternative used to remove the diethyl ether involves heating the crystallization solution at ambient or reduced pressure, as described in U.S. Pat. No. 7,238,336 to Lund et al. For instance, if the diethyl ether is removed under vacuum, the crystallization solution may be heated at a temperature ranging from approximately 50° C. to approximately 60° C. However, if the diethyl ether is removed at ambient pressure, a temperature ranging from approximately 80° C. to approximately 100° C., such as from approximately 80° C. to approximately 97° C., may be used. A rate at which the diethyl ether is removed may affect the formation of the α-alane. If the diethyl ether is removed too quickly, the alane-ether complex may precipitate from the crystallization solution rather than forming the crystals of the α-alane. However, if the diethyl ether is removed too slowly, the crystallization process may be too long for practical and economical purposes.

Thus, as described above, a number of methods of preparing solvated alane complexes are known. In addition, a number of methods for desolvating solvated alane complexes have been described in the literature. However, DOW Chemical Company is the only known company to have carried out the preparation of alane on a commercial scale.

Given the attractive properties of alane for hydrogen storage, it is perhaps surprising that its use is not more widespread. The reasons for this lie in its challenging synthesis and high reactivity. According to the chemical literature, the most common method of synthesis—the Dow Method—proceeds as shown in Reactions 1 and 2. The challenges in this process lie firstly in the removal, without hydrogen loss, of the diethyl ether solvent (Et₂O) from the etherate (AlH₃-nEt₂O) produced in Reaction 1, to obtain the single α-phase that by nature of its structure has the highest hydrogen density of the seven known polymorphs of AlH₃. Secondly, the cost of the process is inflated on account of vacuum drying (Reaction 2) and the high cost of the LiAlH₄ precursor.

3LiAlH₄+AlCl₃−(Et₂O solvent)→3LiCl+AlH₃-nEt₂O Reaction 1

LiAlH₄+AlH₃-nEt₂O−(65° C., in vacuo)→LiAlH₄+AlH₃+Et₂O Reaction 2

Current methods for the preparation of alane are expensive because of, among other things, the high cost of desolvation to prepare the stable α-alane crystalline phase. It would be desirable to reproducibly produce a high yield of α-alane using a low-cost method.

An object of the present invention is to provide an improved low-cost method for the preparation of α-alane suitable for use as a solid hydrogen storage and release material.

### SUMMARY

According to one aspect of the invention, α-alane is produced by a method including the steps: preparing an alane-etherate solution comprising an alane-etherate in a solvent; desolvating the alane-etherate solution by electrospraying in an inert atmosphere; and collecting the α-alane. Embodiments can include one or more of the following features:
the step of desolvating the alane-etherate solution includes forming droplets of the solution by applying a voltage to the solution;
the alane-etherate solution includes an alane-etherate complex and a solvent; the solvent can consist essentially of diethyl ether; the electrospraying can be performed at a temperature from greater than 60° C. to less than 140° C.; the electrospraying can be performed at a temperature of at least 65° C.; the electrospraying can be performed at a temperature less than 125° C.; the electrospraying can be performed at a temperature no greater than 100° C.
the alane-etherate solution contains 0.25 weight percent to 2 weight percent alane; the alane-etherate solution can contain at least 0.5 weight percent alane; the alane-etherate solution can contain no more than 1.5 weight percent alane; the alane-etherate solution can contain no more than 1.0 weight percent alane;
a step of annealing follows the step of desolvating the alane-etherate solution and the step of collecting the α-alane; the step of annealing can be performed at a temperature of from 65° C. to less than 120° C.; the step of annealing can be performed at a temperature of from 65° C. to 100° C.
the step of collecting the α-alane immediately follows the step of desolvating the alane-etherate solution;
in the step of desolvating the alane etherate solution, the solution is sprayed simultaneously from a plurality of nozzles;
the collected α-alane is pelletized;
the alane-etherate solution is prepared by reacting at least one metal aluminum hydride with at least one proton-donating compound; the proton-donating compound can be an acid; the acid can be one or any combination of hydrochloric acid, sulfuric acid and methane sulfonic acid; the at least one metal aluminum hydride includes a metal from Group 1 of the Periodic Table of the Elements; the metal from Group 1 of the Periodic Table of the elements can be lithium or sodium;
the alane-etherate solution is prepared by reacting at least on alkyl halide with at least one metal aluminum hydride; the at least one alkyl halide can be benzyl chloride or n-butyl bromide; the at least one metal aluminum hydride can include a metal from the Group 1 of the Periodic Table of the Elements; the metal from Group 1 of the Periodic Table of the Elements can be lithium or sodium; and
a tertiary amine is added in the step of preparing the alane-etherate solution; the tertiary amine can be a trialkylamine.

Desolvation of an alane-etherate complex is accomplished by spraying processes such as electospraying and/or electrospinning to provide α-alane with superior purity and properties to conventional desolvation methods. The process for producing alane is superior to existing methods because of the lower amounts of solvents used, lower cost, and higher purity of the alane-etherate complex. These and other advantages of the invention will be further understood and appreciated by those skilled in the art by reference to the following written specification and claims.

### BRIEF DESCRIPTION OF THE DRAWINGS

In the drawings:

FIG. 1 shows an electrospraying assembly schematic;

FIG. 2 shows TGA results for the electrospraying of 1 weight percent alane-etherate solutions compared to a conventional vacuum drying method;

FIG. 3 shows SEM photos comparing the alane produced by electrospraying to conventionally-dried alane-etherate; and

FIG. 4 is a schematic drawing illustrating the concept of an electrospraying process to produce AlH₃.

### DETAILED DESCRIPTION OF THE PREFERRED EMBODIMENTS

The embodiments of the present inventions described below are not intended to be exhaustive or to limit the invention to the precise forms disclosed in the following detailed description. Rather the embodiments are chosen and described so that others skilled in the art may appreciate and understand the principles and practices of the present inventions.

All publications and patents mentioned herein are incorporated herein by reference in their respective entireties for the purpose of describing and disclosing, for example, the constructs and methodologies that are described in the publications which might be used in connection with the presently described invention. The publications discussed above and throughout the text are provided solely for their disclosure prior to the filing date of the present application. Nothing herein is to be construed as an admission that the inventor is not entitled to antedate such disclosure by virtue of prior invention.

For purposes of description herein, the terms “upper,” “lower,” “right,” “left,” “rear,” “front,” “vertical,” “horizontal,” and derivatives thereof shall relate to the invention as oriented in the figures. However, it is to be understood that the invention may assume various alternative orientations and step sequences, except where expressly specified to the contrary. It is also to be understood that the specific parts, devices and processes illustrated and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The methods referred herein include:
Nuclear Magnetic Resonance, NMR; a probe of the local chemical environment of atoms. Used in this case to explore the local symmetry and connectivity of aluminium atoms and hence deduce the presence of alane, alane-etherate, alumina (Al₂O₃) and the alanate ion (AlH₄⁻). The different atomic environments are identified by the characteristic chemical shift that they produce.
Powder X-ray Diffraction, XRD; a method of investigating the long-range or crystalline structure of materials. This is the most direct way to determine the phase of alane that has been produced.
Thermo gravimetric analysis, TGA; allows the mass change of the sample to be monitored under controlled heating conditions. This can be used to monitor the amount of ether (Et₂O) (the value of n) in AlH₃-nEt₂O, as well as assessing the amount of hydrogen produced and the nature of any impurities.
Thermo-gravimetric analysis with mass spectroscopy, TGA-MS; (also known as IGA) is the same as TGA, but allows the gas released from the sample to be analysed and the identity of certain gases, in this case hydrogen, to be detected by mass spectrometry.
Scanning Electron Microscopy, SEM; is used to image materials at the nanometre scale. In contrast to optical microscopes that only permit materials to be visualised on the micrometre scale, this technique gives more information about the materials at a scale close to their atomic or molecular dimensions.

As used herein, “alane” refers to AlH₃ and can include combinations of the different alane polymorphs. In contrast, when referring to a specific polymorph of alane, the designation of the specific polymorph is used, such as “α-alane.”

The alane used in the invention can have any acceptable purity level. Preferably for fuel cell applications, the alane is free of organic contaminants. For example, the alane is preferably non-adducted and non-solvated by organic species. The hydrogen storage compositions of the present invention can also have a number of applications other than fuel cells. For some of these other applications, e.g., as catalysts, chemical reactants, propellant, and so on, the alane may contain organic species.

The alane can be completely composed (i.e., 100% by weight) of any of the alane compositions described above. Alternatively, the alane can include another compound or material which is not an alane polymorph.

The alane composition is capable of efficiently and controllably producing hydrogen for a sustained period of time. For example, for fuel cell applications, it would be particularly preferred for the alane composition to be capable of releasing adequate levels of hydrogen at a steady rate for a period of several hours or days. For applications where hydrogen demand varies with time, it is possible and preferable to vary the hydrogen desorption rate by varying the temperature.

### Alane-Etherate Complex

The alane-etherate complex can be made by creating alane diethyl etherate using acids in diethyl ether. A solution or a suspension of metal tetrahydroaluminate in diethyl ether is reacted with up to a stoichiometric amount of a suitable acid, as shown in equation (1) below. Suitable acids include sulfuric acid, hydrochloric acid, methanesulfonic acid, and the like. After filtration of the precipitated metal salts, a clear solution of alane-etherate is produced. This solution is stable for several days at lower temperature (e.g., 3° C.) and in the absence of light. When sodium tetrahydroaluminate is used, it is preferred to include up to a stoichiometric amount of a solubilizing agent such as LiCl (X═CO, as shown in equation (2).

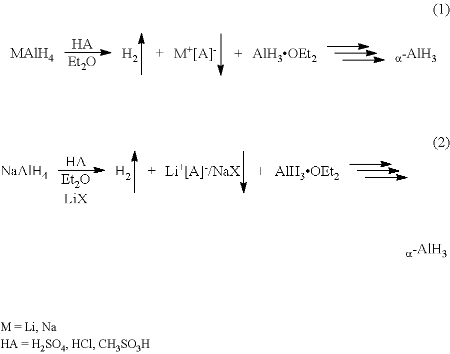

Alane-etherate can also be formed upon reduction of an alkyl halide with a metal alanate in a suitable solvent that contains ether, as shown below. It is preferred that the solvent be 100% diethyl ether; however mixtures of toluene and diethyl ether can be used. The alkyl halide can be any suitable alkyl halide such a 1-bromobutane or benzyl chloride. The stoichiometry of the reaction can be varied such that either the alkyl halide or the metal aluminum hydride can be used in excess. Optionally, when using sodium aluminum hydrides it is desirable to include a soluble Li⁺species to increase the rate of the reaction.

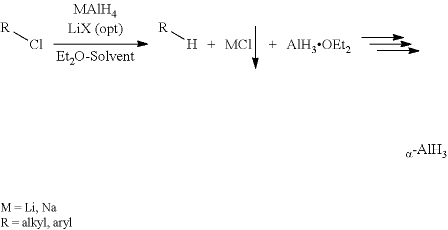

The formation of an alane-tertiary amine adduct, and other alane-solvent complexes can result when using a tertiary amine as part of the reaction. Removal of the solvent and/or the tertiary amine can be carried out using standard protocols. Examples of the reaction processes are shown below. However, any metal alanate (including those disclosed below (Li and Na), others not expressly disclosed herein, or combinations thereof), alkyl halide (including those disclosed herein (benzyl chloride and n-butyl bromide), others not expressly disclosed herein, or combinations thereof), or tertiary amine (including those disclosed below (trialkylamine), others not expressly disclosed herein, or combinations thereof) may be used.

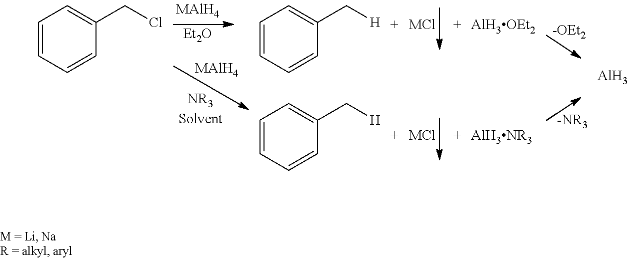

Removal of the tertiary amine can be accomplished by thermally decomposing the tertiary amine-alane adduct in the presence of a catalytic amount of a Group 1 or Group 2 metal hydride or organometallic catalyst as described in U.S. Pat. No. 3,764,666 to Murib, forming alane and the corresponding tertiary amine. As used herein, group designations of the Periodic Table of the Elements are according to the IUPAC (International Union of Pure and Applied Chemistry) Nomenclature of Inorganic Chemistry, Recommendation 2005, in which Group 1 includes the alkali metals, Group 2 includes the alkaline earth metals, Group 3 is the scandium group of transition metals, and so on. The reaction proceeds according to the equation:

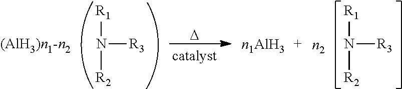

where R₁, R₂, and R₃ are organic radicals, n₁ and n₂ are integers equal to one or more. The process is carried out at a temperature above the decomposition temperature of the tertiary amine-alane adduct to form alane and the corresponding tertiary amine, but below the decomposition temperature of alane. It is preferred that the temperature be less than 90° C., for example, in the range of 35° C. to about 90° C. At temperatures below 35° C., the rate of decomposition is extremely slow, but the process can still be carried out at lower temperatures if speed is not a disadvantage. To prevent hydrolysis of the alane, the reaction mixture should be anhydrous, and the system should be oxygen-free, such as under nitrogen or other inert gas.

To assist in driving the decomposition reaction to completion, at least one of the products should be removed from the reaction mixture, preferably as it is formed. The tertiary amine can be removed from the reaction zone by distillation, desirably under reduced pressure, so as to keep the reaction mixture at below 90° C. The amine also can be removed by sweeping with inert diluent or solvent vapors, or with an inert gas, such as nitrogen. A reduced pressure, if used, is not so low that the tertiary amine-alane adduct is volatilized at the temperature at which the reaction is carried out. Generally, pressures of from about 10⁻⁸ up to about 50 mm of Hg are satisfactory. Reaction is complete when evolution of tertiary amine ceases.

### Electrospraying

Electrospraying employs electricity to disperse a liquid, usually resulting in a fine aerosol. High voltage is applied to a liquid supplied through an emitter (usually a glass or metallic capillary). Ideally the liquid reaching the emitter tip forms a Taylor cone, which emits a liquid jet through its apex. Varicose waves on the surface of the jet lead to the formation of small and highly charged liquid droplets, which are radially dispersed due to Coulomb repulsion. Electrospraying does not involve the use of polymers, so the jet emerging from the Taylor cone forms micro- or nano-scale droplets that dry rapidly, producing a coating of fine particles on the collector.

Similarly to the standard electrospraying, the application of high voltage to a polymer solution can result in the formation of a cone-jet geometry. If the jet turns into very fine fibers instead of breaking into small droplets, the process is known as electrospinning. Electrospinning uses an electrical charge to draw micro- or nano-scale fibers from a liquid. Typically this involves pumping or dripping a polymer solution through a nozzle maintained at a high relative potential. The drops of solution become charged and electrostatic forces counteract the surface tension, at a critical point a jet of liquid is produced from the Taylor cone. As the jet travels through the atmosphere, the solvent evaporates, so when the jet reaches the collector plate it has formed dry polymer fibers. The electrospinning process can be further subdivided into single-phase or coaxial spinning; single-phase uses a single polymer solution in a relatively simple process, while the more complex co-axial spinning uses two solutions pumped through concentric needles, allowing finer control over material properties.

Both of these electro-hydrodynamic processes are controlled and affected by a wide variety parameters. The parameters include: solution parameters (such as viscosity/rheometry, surface tension, vapour pressure, conductivity, and dielectric constant); environmental parameters (such as temperature, and humidity/atmosphere); and process parameters (voltage, nozzle geometry, flow rates, and nozzle and plate separation).

There are a number of different spinning or spraying configurations that may be used, these include: 1) vertical (where the needle points downwards and material is collected on a flat plate); 2) horizontal (where the needle is horizontal and material is collected on a vertical plate); 3) spinning collector (where the material is collected on a spinning drum); and 4) multinozzle (where solution is pumped simultaneously through multiple nozzles housed in a discrete unit). These units may be joined to many other units to provide a scalable technology.

A stable spraying/spinning process is one where a Taylor cone forms consistently and shows little deviation during the process. The importance of this is: 1) to provide consistent fibers/beads/particles; and 2) to produce a scalable process.

Electrospraying can be used to reduce the amount of solvent in an alane-etherate solution. This is due to rapid evaporation occurring from the small particles produced during electrospraying. Electrospraying also removes more solvent than vacuum drying alone, and can potentially eliminate a vacuuming drying step in the process of alane production. Electrospraying also results in a more consistent particle size and morphology as described below.

Generation of alane solutions requires manipulation of air-sensitive materials. Initial handling can be performed using a glove box, while a Schlenk line can be employed in subsequent solution generation. The glove box provides a contained inert atmosphere, it uses a gas circulating system with catalysts and adsorbents to remove trace amounts of oxygen and water from the inert atmosphere such that these contaminants are maintained at concentrations below 10 ppm. The Schlenk line consists of a double manifold, one containing a flowing inert gas and the other connected to a vacuum. These sections can be selectively accessed using a three-way valve that is connected via a rubber tube to the sample vessel.

Solutions produced using the Schlenk line can be transferred to the spraying rig, which also needs to operate under an inert atmosphere, such as a simple system of flowing nitrogen gas. Alternatively, the inert atmosphere can include circulating nitrogen through catalysts that remove solvents, oxygen and water from the gas stream.

A crystallization additive may be added to the alane-etherate solution to help form the α-alane crystals. The crystallization additive may promote growth of the a polymorph by providing a nucleation site for the a polymorph. The crystallization additive may also suppress formation of the undesirable polymorphs. It is also believed that early precipitation of the crystals may promote the growth of the a polymorph. Seed crystals of α-alane may be added during the crystallization to promote the growth of the α-alane. The seed crystals may subsequently be incorporated into the α-alane. The crystallization additive may also be an aprotic, electron-rich material. For instance, the crystallization additive may be an olefin, a polyolefin, an anisole, a polydimethyl siloxane, a tertiary amine, an aliphatic or aromatic ether, or mixtures thereof. The olefin may include, but is not limited to, squalene, cyclododecatriene, norbornylene, norbornadiene, a phenyl terminated polybutadiene, and mixtures thereof The anisole may include, but is not limited to, 2,4-dimethyl anisole, 3,5-dimethyl anisole, 2,6-dimethyl anisole, and mixtures thereof These compounds are commercially available from various manufacturers, such as from Sigma-Aldrich Co. (St. Louis, Mo.). The crystallization additive may also be polydimethyl siloxane or LiAlH₄. The crystallization additive may also be a combination of any of the additives.

The electrospraying process can be carried out at an elevated temperature (solution temperature and/or spray chamber temperature) to increase solvent removal. For example, a temperature of greater than 60° C. can be used, preferably at least 65° C. At lower temperatures solvent removal will not be as efficient, and the alane produced may not have the desired characteristics (e.g., morphology and particle size). To minimize the release of hydrogen gas from the alane, the temperature should be less than 140° C., preferably less than 120° C., and more preferably no greater than 100° C. The collected alane can be heated (annealed), during collection (e.g., by heating the collection plate) or afterwards, to remove remaining solvent and/or to achieve the desired alane morphology (α-alane). This temperature is preferably at least 65° C. and less than 120° C., more preferably no greater than 100° C. to prevent or minimize the release of hydrogen gas.

Examples have been set forth below for the purpose of illustration and to describe the best mode of the invention at the present time. However, the scope of this invention is not to be in any way limited by the examples set forth herein.

### EXAMPLE 1

### Preparation of Alane-Etherate using Lithium Aluminum Hydride and Hydrochloric Acid

Lithium aluminum hydride (0.76 g, 20 mmol) was weighed into a 100 mL round-bottom flask containing a magnetic stirring bar in a glovebox under Ar atmosphere. The flask was sealed with a rubber septa and put under Ar on a Schlenk line. Anhydrous diethyl ether (22 mL) was added. The septum was replaced quickly with a pressure-equalizing addition funnel that was purged with Ar. A solution of 1M HCl in diethyl ether (16 mL, 16 mmol) was added dropwise over 30 minutes while stirring the reaction mixture in an ice-water bath. After addition of the acid was complete, the reaction mixture was allowed to warm to room temperature with stirring until hydrogen evolution ceased. The slurry was then filtered using a filter cannula, and the insoluble material was washed once with fresh diethyl ether (10 mL total). The combined filtrate had 1 weight percent of AlH₃.

### EXAMPLE 2

### Preparation of Alane-Etherate using Lithium Aluminum Hydride and Sulfuric Acid

A commercial solution of lithium aluminum hydride in diethyl ether (1 M, 37.5 mL, 37.5 mmol) was added to a 100 mL round-bottom flask containing a magnetic stiffing bar under Ar atmosphere. Anhydrous diethyl ether (122.5 mL) was added, and the mixture was cooled in an ice-water bath with stirring under Ar. Concentrated sulfuric acid (reagent grade, 95-98 percent, 1.60 mL, 30 mmol) was added to this solution dropwise via syringe. After addition of the acid was complete, the reaction mixture was allowed to warm to room temperature with stirring until hydrogen evolution ceased. The slurry was then filtered using a filter cannula, and the insoluble material was washed once with fresh diethyl ether (20 mL). The combined filtrate had 0.5 weight percent of AlH₃.

### EXAMPLE 3

### Preparation of Alane-Etherate using Sodium Aluminum Hydride, Lithium Chloride and Hydrochloric Acid

Sodium aluminum hydride (1.35 g, 25 mmol) and lithium chloride (0.848 g, 20 mmol) are combined in a 100 mL round-bottom flask containing a magnetic stirring bar in a glovebox under Ar atmosphere. The flask is sealed with a rubber septa and put under Ar on a Schlenk line. Anhydrous diethyl ether (30 mL) is added. The septum is replaced quickly with a condenser that is being purged with Ar. This slurry is stirred at reflux for three hours under Ar atmosphere, then cooled to 0° C. using an ice-water bath. The condenser is replaced quickly with a pressure-equalizing addition funnel that is being purged with Ar. A solution of 1 M HCl in diethyl ether (20 mL, 20 mmol) is added to the addition funnel using a syringe, then added dropwise to the reaction mixture over 30 minutes while stirring in an ice-water bath. After addition of the acid is complete, the reaction mixture is allowed to warm to room temperature with stirring until hydrogen evolution ceased. The slurry is then filtered using a filter cannula, and the insoluble material is washed once with fresh diethyl ether (10 mL). The combined filtrate containing alane-etherate in ether solution (ca. 1 weight percent AlH₃) can be used directly in the electrospraying process.

### EXAMPLE 4

### Preparation of Alane-Etherate using Benzyl Chloride and Lithium Aluminum Hydride

Anhydrous diethyl ether (15 mL) is added to a dry 100 mL single neck round bottom flask equipped with a magnetic stir bar and reflux condenser under Ar atmosphere. A solution of lithium aluminum hydride in diethyl ether (1 M, 1185 mL, 1185 mmol) is added via syringe with stiffing under Ar. Neat benzyl chloride (0.91 mL, 7.90 mmol) is then added via syringe and the reaction mixture is warmed to reflux and stirred overnight under Ar. GC/MS analysis of an aliquot taken from the reaction mixture indicates when the conversion of benzyl chloride to toluene is complete. After cooling to room temperature, the reaction slurry is filtered under Ar, providing a 0.33 M solution of alane-etherate in diethyl ether solution.

### EXAMPLE 5

### Preparation of Alane-Etherate using Benzyl Chloride and a Mixture of Sodium Aluminum Hydride and Lithium Aluminum Hydride

Sodium aluminum hydride (0.427 g, 7.90 mmol) is added to a dry 100 mL single neck round bottom flask equipped with a magnetic stir bar, sealed with a rubber septum, and put under Ar atmosphere. Anhydrous diethyl ether (25 mL) is added to this flask using a syringe, and the septum is then quickly replaced by a reflux condenser under flow of Ar. A solution of lithium aluminum hydride in diethyl ether (1 M, 1.98 mL s, 1.98 mmol) is added via syringe with stirring under Ar, followed by neat benzyl chloride (0.91 mL, 7.90 mmol). The reaction mixture is warmed to reflux and stirred overnight under Ar. GC/MS analysis of an aliquot taken from the reaction mixture would show that the conversion of benzyl chloride to toluene is complete. After cooling to room temperature, the reaction slurry is filtered under Ar, providing a 0.33 M solution of alane-etherate containing 0.25 eq of lithium aluminum hydride in diethyl ether solution.

### EXAMPLE 6

### Electrospraying of Alane-Ether Solutions

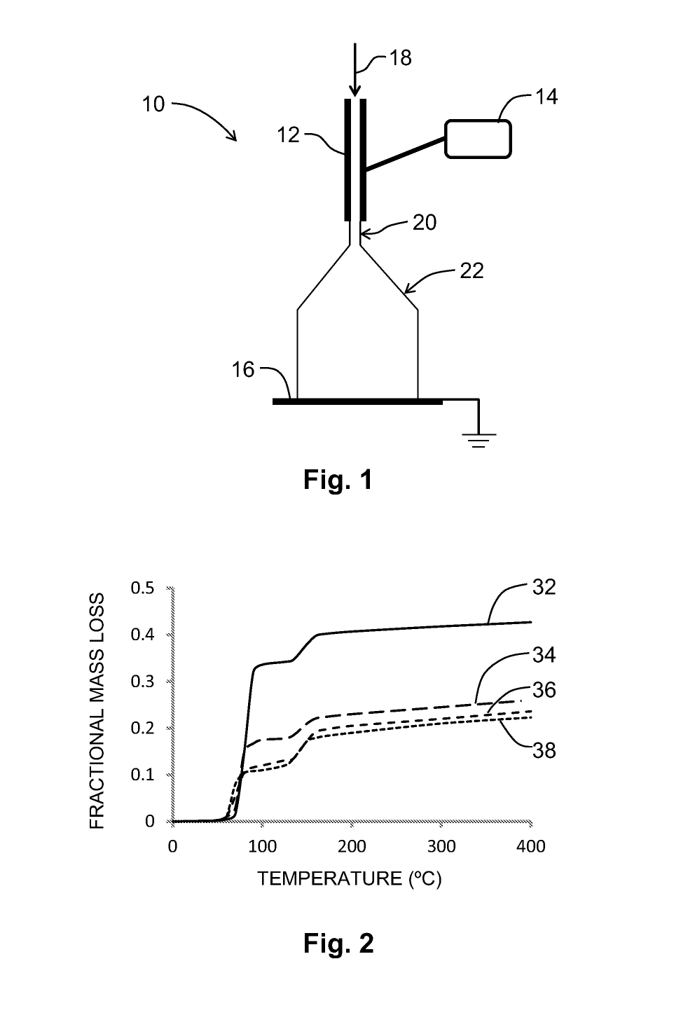

An electrospraying apparatus as shown in FIG. 1 was assembled in an inert-atmosphere water-free glovebox. The apparatus 10 included a nozzle 12 through which an alane-etherate solution (alane in diethyl ether) was sprayed. A high voltage direct current power supply 14 was connected to the nozzle 12. The charged liquid spray included a straight jet 20 and a plume 22 of droplets, and material was collected on a collection plate 16. The process parameters, such as temperature, applied voltages, nozzle geometry, solution flow rate, the distance between nozzle and collection plate, and direction of spraying can be adjusted to control the amount of solvent removed and the particle size distribution and morphology of the alane produced, as well as to prevent or eliminate the release of hydrogen gas from the alane during the process.

The electrosprayed alane can be annealed by controlling the ambient temperature of the spraying chamber, or by heating the collecting plate to the desired temperature. The TGA results for electrospraying of a 1 weight percent solution of alane in diethyl ether are shown in FIG. 2 and compared to the same solution dried using conventional methods. In FIG. 2, the annealing temperature in degrees Celsius is shown on the x-axis and the fractional mass loss on the y-axis. Line 32 shows conventionally dried solution, and lines 34, 36 and 38 show electrosprayed solution, with the spraying done vertically (as in FIG. 1) in line 34 and horizontally in each of lines 36 and 38. This data shows a significantly greater reduction in residual ether using the electrospray process (to about 83 weight percent) compared to conventional drying. The majority of the ether was removed at annealing temperatures from about 60° C. to 100° C. Hydrogen gas was evolved beginning at about 120° C.

NMR testing was done on material collected on the collection plate. The ²⁷Al-NMR results showed only the presence of residual LiAlH₄ and alane-etherate. TGA testing was performed on electrosprayed alane-etherate that was annealed at 65° C. The results showed pure hydrogen was released. The onset of dehydrogenation was lower compared to macrocrystalline alane (ca. 120° C. vs. 180° C.), presumably because of the small, uniform particle size of the electrosprayed alane. X-ray diffraction confirmed the formation of α-alane upon annealing at 65° C.

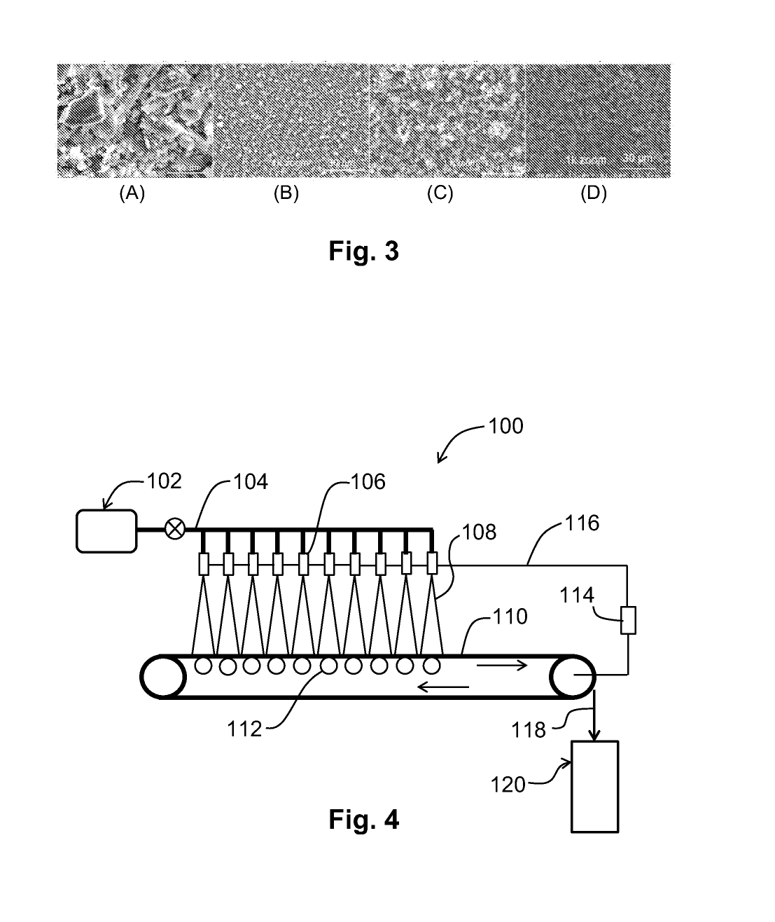

The SEM images in FIG. 3 show the difference in particle size and morphology between conventionally dried alane and electrosprayed alane-etherate. Image (A) shows alane-etherate that was vacuum dried and ground with a mortar and pestle, image (B) shows 0.5 weight percent alane in diethyl ether after electrospraying, image (C) shows 1.0 weight percent alane in diethyl ether after electrospraying, and image (D) shows 1.0 weight percent alane in diethyl ether after electrospraying and annealing at 65° C. Electrosprayed 1 weight percent alane solutions had a range of particle sizes from 1 um to 500 nm, while electrosprayed 0.5 weight percent alane solutions had a particle size in the range of 300 nm to 100 nm Thus, the solution concentration affected particle size, with the more dilute alane solution producing smaller particles. The uniformity of the particle size (fine particle size with consistent morphology) was maintained after annealing the electrosprayed alane particles at 65° C. In comparison, the vacuum dried sample, even after grinding, showed a very inconsistent morphology.

This example demonstrates that electrospraying improves the process of alane production, by making it easier to remove the solvent, eliminating the need for a vacuum drying stage, and consistently producing the correct phase with a beneficial morphology.

There are two possible ways that electrospraying could work on a large scale:

1. The spraying process is refined such that AlH₃ is obtained directly, without subsequent annealing or other treatment; and
2. The spraying process is followed immediately by an annealing stage. The first alternative is preferred, but the second is acceptable, particularly if done in a continuous process, for example when the etherate is sprayed onto a hot roller where it is annealed then collected for pelletization, such as shown in FIG. 4. The alane preparation process 100 includes preparation of an alane-etherate solution, as represented by reference number 102. The solution is supplied (such as by a manifold 104), to a plurality of spray nozzles 106. A high voltage direct current from a power source 114 is applied via circuit 116 to the nozzles 106, producing plumes 108 of droplets of the alane-etherate. The at least partially desolvated material is collected on a conveyor 110, which can be heated (e.g., by heated rollers 112) to anneal the alane and/or remove the remaining ether. The alane is removed from the conveyor and transferred (arrow 118) for further processing (e.g. stabilization, pelletization, collection, packaging, etc.), as represented by reference number 120.

Alane-etherate that is desolvated by electrospraying can be produced with a small, controllable particle size, making the alane more advantageous for use in hydrogen generators based on thermolysis or hydrolysis.

Aspects can be altered and/or extended without losing the advantages of the invention. For example:
The method for preparing the alane-etherate complex solution.
Specifics of the electrospraying process, including: type of nozzle used for atomization, atomization method, droplet size, gas-to-feed ratios, feed concentration, single-capillary, dual-capillary, cone-jet mode, liquid conductivity, liquid flow rate, solution concentration, orifice diameter, capillary-to-plate distance, radioactive source strength, carrier gas flow rate, and temperature.

In a modification of the electrospraying process, the alane-etherate solution can include a polymer or polymer precursor, and fibers of alane can be produced using an electrospinning process, as described above.

The above description is considered that of the preferred embodiments only. Modifications of the invention will occur to those skilled in the art and to those who make or use the invention. Therefore, it is understood that the embodiments described above is merely for illustrative purposes and not intended to limit the scope of the invention, which is defined by the following claims as interpreted according to the principles of patent law, including the Doctrine of Equivalents.

1. A method of producing α-alane comprising:
preparing an alane-etherate solution comprising an alane-etherate in a solvent;
desolvating the alane-etherate solution; forming droplets of the solution by applying a voltage to the solution, in an inert atmosphere, and electrospraying the solution; and,
collecting the α-alane.

2. (canceled)

3. The method of claim 1, wherein the alane-etherate solution comprises an alane-etherate complex and a solvent.

4. The method of claim 3, wherein the solvent consists essentially of diethyl ether, and the electrospraying is performed at a temperature in a range of from greater than 60° C. to less than 100° C.

5. (canceled)

6. The method of claim 1, wherein the alane-etherate solution contains alane in a range of from 0.25 weight percent to 2 weight percent, relative to the weight of the entire solution.

7. The method of claim 6, wherein the alane-etherate solution contains no more than 1.0 weight percent alane.

8. The method of claim 1, wherein a step of annealing follows the step of desolvating the alane-etherate solution and the step of collecting the α-alane.

9. (canceled)

10. (canceled)

11. The method of claim 1, wherein in the step of desolvating the alane etherate solution, the solution is sprayed simultaneously from a plurality of nozzles.

12. The method of claim 1, further comprising pelletizing the collected α-alane.

13. The method of claim 1, wherein the alane-etherate solution is prepared by reacting at least one metal aluminum hydride with at least one proton-donating compound.

14. The method of claim 13, wherein the at least one metal aluminum hydride comprises lithium, sodium, potassium, or cesium, and the at least one proton donating compound comprises hydrochloric acid, sulfuric acid, methane sulfonic acid, or a mixture thereof.

15. The method of claim 1, wherein the alane-etherate solution is prepared by reacting one or more alkyl halides with one or more metal aluminum hydrides.

16. The method of claim 15, wherein the at least one alkyl halide is benzyl chloride or n-butyl bromide.

17. The method of claim 15, wherein the at least one metal aluminum hydride comprises lithium, sodium, potassium, or cesium.

18. The method of claim 15, wherein a tertiary amine is added in the step of preparing the alane-etherate solution.

19. (canceled)

20. The method of claim 14, wherein the at least one proton donating compound consists of one of or a combination of hydrochloric acid and methane sulfonic acid.

21. The method of claim 13, wherein the one or more metal tetrahydroaluminates comprises one of LiAlH₄ and NaAlH₄.

22. The method of claim 15, wherein the one or more metal tetrahydroaluminates comprises one of LiAlH₄ and NaAlH₄.

23. The method of claim 1, wherein the solvent comprises diethyl ether.

24. The method of claim 1, wherein the alane-etherate solution further comprises a polymer or polymer precursor, the desolvation comprises electrospinning, and the collected α-alane is in the form of a fiber.

25. The method of claim 23, wherein the solvent further comprises a soluble Li⁺species.

26. A composition prepared by the method of claim 1 , wherein the α-alane has a uniform particle size in a range of from 100 nm to 300 nm.

27. A composition prepared by the method of claim 1 , wherein the α-alane has a uniform particle size in a range of from 500 nm to 1000 nm.

28. A polymer fiber composition prepared by the method of claim 24, wherein the fiber comprises α-alane.
